(19) United States
(12) Patent Application Publication
(10) Pub. No.: US 2013/0005481 A1
(43) Pub. Date: Jan. 3, 2013

(54) METHOD AND SERVER SYSTEM

(75) Inventors: Tomomi TAGAWA, Tokyo (JP); Gota GOTO, Tokyo (JP); Akira YAMASHITA, Tokyo (JP)

(73) Assignee: NAMCO BANDAI Games Inc., Tokyo (JP)

(21) Appl. No.: 13/432,212

(22) Filed: Mar. 28, 2012

(30) Foreign Application Priority Data
Jun. 29, 2011 (JP) 2011-144189

(51) Int. Cl. G06F 17/00

(52) U.S. Cl. 463/42

(57) ABSTRACT

When a game situation has satisfied a participation situation condition, a posting site is accessed, and a message that includes participation URL address for another person to participate in the game is automatically posted to the posting site. Another person can participate in the game played by the player by accessing the participation URL address included in the message. A participating character that has been automatically generated appears in the game played by the player. A game screen that shows the state of the game in which the other person participates is displayed on a terminal of the other person.

Japanese Patent Application No. 2011-144189 filed on Jun. 29, 2011, is hereby incorporated by reference in its entirety.

### BACKGROUND

The present invention relates to a method and a server system.

A website referred to as “posting site” is present on the Internet. The posting site receives text data, image data, and the like from an information terminal that has accessed a given web page, and distributes the received data so that the users can view the data. For example, the posting site is used to exchange game strategy information (see JP-A-2010-46159, for example).

The posting site may be configured to allow each user to register favorite users (posters), and selectively display the messages posted by the favorite users (e.g., the “Follow” setting used in “Twitter (registered trademark)”).

### SUMMARY

According to one aspect of the invention, there is provided a method that causes a server system to control a process of a game played by a registered player, the method comprising:

posting a message that is posted by the registered player and includes a participation code to a posting site when a game situation of the registered player has satisfied a given participation situation condition that allows an unregistered player to participate in the game; and

changing the process of the game played when the server system has been accessed by the unregistered player using the participation code.

According to another aspect of the invention, there is provided a server system comprising:

a posting section that posts a message that is posted by a registered player and includes a participation code to a posting site when a game situation of the registered player has satisfied a given participation situation condition that allows an unregistered player to participate in the game; and

a game process change section that changes a process of a game played by the registered player when the server system has been accessed by the unregistered player using the participation code.

### BRIEF DESCRIPTION OF THE DRAWINGS

FIG. 1 is a schematic configuration diagram of a system according to one embodiment of the invention.

FIG. 2 shows a data configuration example of account registration data.

FIG. 3 shows an example of the appearance of a portable game device.

FIG. 4 shows an example of a game screen displayed when a participation situation condition has been satisfied.

FIG. 5 shows an example of a screen that requests the player to agree to access to a posting site.

FIG. 6 shows an example of a screen that prompts the player to input account information for accessing a posting site.

FIG. 7 shows an example of a screen that requests the player to edit a message.

FIG. 8 is a view illustrating participation of another person in the game.

FIG. 9 shows an example of a game screen displayed when another person has participated in the game.

FIG. 10 shows an example of a registration prompt screen.

FIG. 11 is a functional configuration diagram of a game server system.

FIG. 12 shows a data configuration example of player registration data.

FIG. 13 shows a data configuration example of participation event data.

FIG. 14 shows a data configuration example of a participation situation condition list.

FIG. 15 shows a data configuration example of a benefit list.

FIG. 16 is a flowchart showing a game control process.

FIG. 17 is a flowchart showing a participation control process.

FIG. 18 is a flowchart showing a participation control process.

### DESCRIPTION OF EXEMPLARY EMBODIMENTS

Several aspects of the invention may make it possible to implement a novel game using a posting site.

According to one embodiment of the invention, there is provided a method that causes a server system to control a process of a game played by a registered player, the method comprising:

posting a message that is posted by the registered player and includes a participation code to a posting site when a game situation of the registered player has satisfied a given participation situation condition that allows an unregistered player to participate in the game; and

changing the process of the game played when the server system has been accessed by the unregistered player using the participation code.

According to another embodiment of the invention, there is provided a server system comprising:

a posting section that posts a message that is posted by a registered player and includes a participation code to a posting site when a game situation of the registered player has satisfied a given participation situation condition that allows an unregistered player to participate in the game; and

a game process change section that changes a process of a game played by the registered player when the server system has been accessed by the unregistered player using the participation code.

According to the above configuration, a message that is posted by the registered player and includes the participation code is posted to the posting site when the game situation of the registered player has satisfied the given participation situation condition. The process of the game played by the registered player is changed when the server system has been accessed by the unregistered player using the participation code. This makes it possible to implement a novel game that enables an unregistered player to participate in the game played by the registered player by utilizing the posting site. The registered player can have a novel game experience in which the registered player is linked to another player through the posting site.

The method may further comprise:

transmitting a signal that notifies the unregistered player that the unregistered player has participated in the game played by the registered player when the server system has been accessed by the unregistered player.

According to the above feature, a signal that notifies the unregistered player that the unregistered player has participated in the game played by the registered player is transmitted to the unregistered player who has accessed the server system using the participation code. Since the unregistered player is notified that the unregistered player has participated in the game played by another player, the unregistered player can experience the game, and may become interested in the game.

The method may further comprise:

generating a character of the unregistered player when the server system has been accessed by the unregistered player; and

transmitting a display control signal for a game screen in which a character of the registered player and the character of the unregistered player appear when the server system has been accessed by the unregistered player.

According to the above feature, a game screen where the character of the registered player and the character of the unregistered player appear is displayed on a terminal of the unregistered player. Since the character of the unregistered player also appears in the game, it is expected that the unregistered player will become more interested in the game.

The method may further comprise:

transmitting a display control signal for a prompt screen that prompts the unregistered player to register himself as a player after transmitting the display control signal for the game screen; and

setting the character of the unregistered player as a character that is used in the game, and giving a given benefit to the unregistered player when a signal that indicates that the unregistered player has registered himself as a player has been received.

According to the above feature, the prompt screen that prompts the unregistered player to register himself as a player is displayed on the terminal of the unregistered player after the game screen has been displayed. When the unregistered player has registered himself as a player, the character of the unregistered player is set as a character that is used in the game, and a benefit is given to the unregistered player. This makes it possible to prompt the unregistered player to register himself as a player of the game, and use the character that appeared in the game as his character. This is effective as the prompt means. It is expected that a further effect can be obtained by giving a benefit to the unregistered player.

In the method,

the posting of the message may include posting the message when the participation situation condition has been satisfied, and a signal that requests the unregistered player to participate in the game has been received from the registered player.

According to the above feature, the message including the participation code is posted when the registered player has requested an unregistered player to participate in the game. Specifically, an unregistered player can participate in the game only when the registered player has requested an unregistered player to participate in the game.

The method may further comprise:

posting a message that is posted by the registered player and indicates that the unregistered player has participated in the game played by the registered player to the posting site when the server system has been accessed by the unregistered player.

According to the above feature, a message that is posted by the registered player and indicates that the unregistered player has participated in the game is posted to the posting site when the unregistered player has participated in the game. Therefore, the unregistered player who has participated in the game feels that he is linked to the registered player. When the message has been posted to the posting site, other users who use the posting site may become interested in the game.

According to another embodiment of the invention, there is provided a method that causes a server system to control a process of a game played by a registered player, the method comprising:

transmitting a signal that instructs the registered player to post a message that includes a participation code to a posting site when a game situation of the registered player has satisfied a given participation situation condition that allows an unregistered player to participate in the game; and

changing the process of the game played when the server system has been accessed by the unregistered player using the participation code.

According to another embodiment of the invention, there is provided a server system comprising:

a posting instruction section that transmits a signal that instructs a registered player to post a message that includes a participation code to a posting site when a game situation of the registered player has satisfied a given participation situation condition that allows an unregistered player to participate in the game; and

a game process change section that changes a process of a game played by the registered player when the server system has been accessed by the unregistered player using the participation code.

According to the above configuration, the terminal of the registered player posts a message that includes the participation code for another person to participate in the game played by the registered player. This also achieves the above effects.

Exemplary embodiments of the invention are described below with reference to the drawings. Note that the invention is not limited to the following exemplary embodiments.

System Configuration

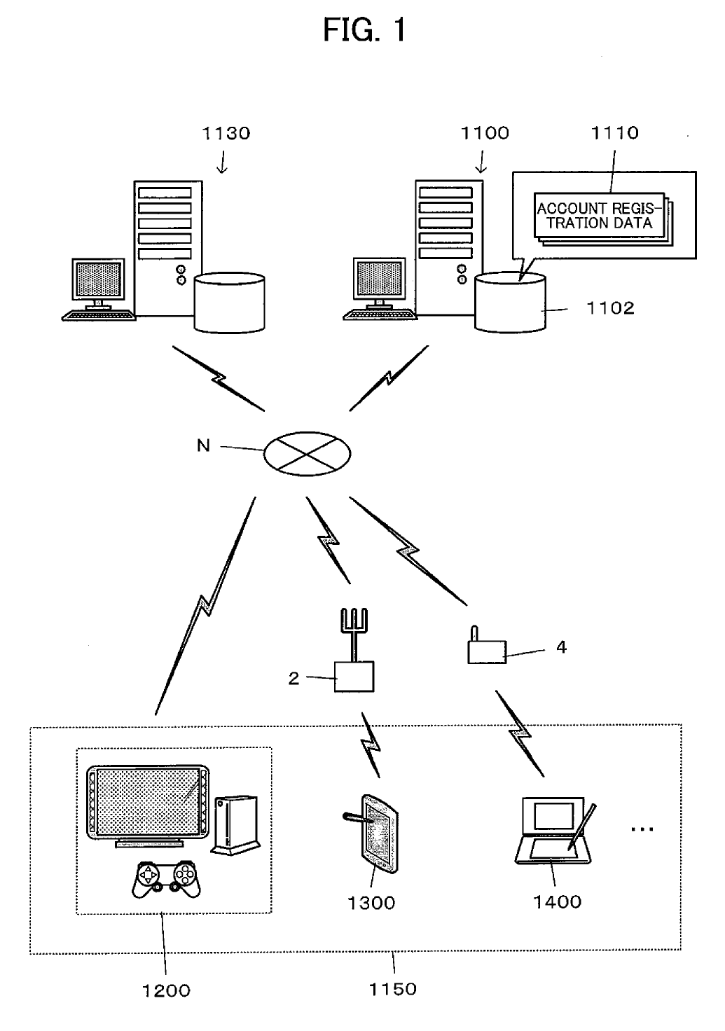

FIG. 1 shows an overall configuration example of a system according to one embodiment of the invention. As shown in FIG. 1, the system according to one embodiment of the invention includes a posting site server system 1100, a game server system 1130, and a terminal 1150, the posting site server system 1100, the game server system 1130, and the terminal 1150 being connected via a communication channel N so that the posting site server system 1100, the game server system 1130, and the terminal 1150 can exchange data.

The communication channel N allows data to be exchanged (transmitted and received) therethrough. Specifically, the communication channel N includes a communication network such as a local area network (LAN) using a private line (private cable) for direct connection, Ethernet (registered trademark), and the like, a telecommunication network, a cable network, and the Internet. The communication method may be a cable communication method or a wireless communication method.

The posting site server system 1100 implements a posting site service. The posting site service is similar to a blog service, and allows the user to post a message, or view a message posted by another user. A user who desires to use the posting site service registers himself on the posting site to acquire an account. The user accesses the posting site using account information (e.g., user name and password) that have been set when acquiring the account. When the user has been authenticated, the user can post a message to the posting site, or view a message posted by another user. The posting site service is implemented by “Twitter” or the like.

A storage 1102 included in the posting site server system 1100 stores various types of data for implementing the posting site. For example, the storage 1102 stores account registration data 1110 for managing the account assigned to the user via user registration.

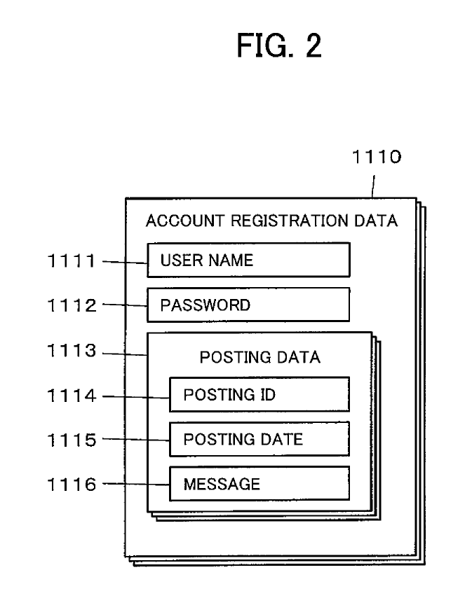

FIG. 2 shows an example of the data configuration of the account registration data 1110. As shown in FIG. 2, the account registration data 1110 is generated corresponding to each registered user, and includes a user name 1111, a password 1112, posting data 1113, and the like. The posting data 1113 is data about a posting using the corresponding account, and includes a posting ID, a posting date, a message, and the like. In one embodiment of the invention, the message includes at least text data, and may include image data and link information.

The game server system 1130 manages, generates, and distributes various types of information for implementing a game (RPG) according to one embodiment of the invention. More Specifically, the game server system 1130 (1) registers and manages each player, and (2) controls the process of the game in the terminal 1150.

The terminal 1150 is a device that allows the player to play the game or use the posting site. The terminal 1150 may be implemented by an electronic device that includes a computer, such as a consumer game device 1200, a smartphone (may be a mobile phone) 1300, or a portable game device 1400. The smartphone 1300 can connect to the communication channel N via a mobile phone base station 2. The portable game device 1400 can connect to the communication channel N via a wireless base station 4. The consumer game device 1200 can connect to the communication channel N via a fixed line or the wireless base station 4.

The terminal 1150 functions as a game terminal that connects to the game server system 1130 via a communication channel, and allows the user to play the game, and also functions as a user terminal that has a web browser function, connects to the posting site server system 1100 via a communication channel, and allows the user to use the posting site.

Note that the term “player” used herein refers to a person who mainly plays the game, and the term “user” used herein refers to a person who mainly uses the posting site. A player who plays the game has registered himself as a user of the posting site, and acquired an account.

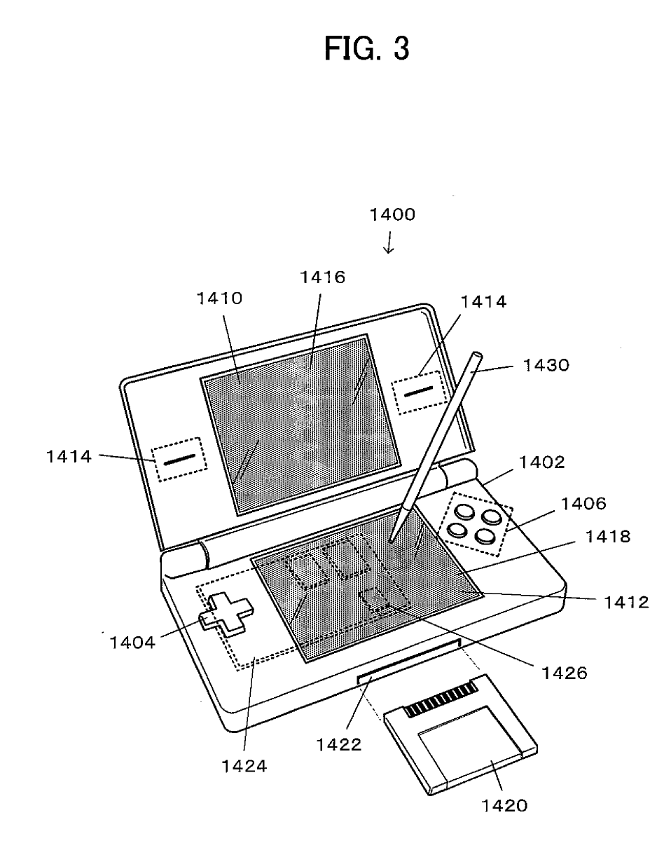

FIG. 3 shows an example of the appearance of the portable game device 1400 (i.e., terminal 1150). As shown in FIG. 3, the portable game device 1400 includes an arrow key 1404, button switches 1406, a first liquid crystal display 1410, a second liquid crystal display 1412, a speaker 1414, a control unit 1424, and a flip-top main body 1402 that can be opened and closed through a hinge, the arrow key 1404, the button switches 1406, the first liquid crystal display 1410, the second liquid crystal display 1412, the speaker 1414, and the control unit 1424 being provided on or in the main body 1402. Touch panels 1416 and 1418 that allow the user to perform an input operation by touching an arbitrary position within the display screen using a stylus pen 1430, a finger, or the like are provided on the display screens of the first liquid crystal display 1410 and the second liquid crystal display 1412, respectively.

The main body 1402 includes a memory card reader 1422 that reads and writes data from and into a memory card 1420 (i.e., computer-readable information storage medium). The memory card 1420 stores a program and setting data necessary for the control unit 1424 to perform various game calculation processes. A built-in battery (not shown), a power button (not shown), a volume control button (not shown), and the like are provided in or on the main body 1402.

The control unit 1424 corresponds to a control board of a game device, and includes a microprocessor (e.g., central processing unit (CPU), graphics processing unit (GPU), and digital signal processor (DSP)), an application-given integrated circuit (ASIC), and an IC memory (e.g., VRAM, RAM, and ROM).

The control unit 1424 also includes a wireless communication module 1426 for connecting to the wireless base station 4 via a wireless communication channel, a driver circuit that drives the first liquid crystal display 1410 and the liquid crystal display 1412, a circuit that receives signals from the arrow key 1404 and the button switches 1406, and an amplifier circuit that outputs a sound signal to the speaker 1114 (i.e., interface (I/F) circuits). The elements included in the control unit 1424 are electrically connected through a bus circuit so that data can be read from and written into the elements, or signals can be exchanged between the elements.

The control unit 1424 reads a program and data stored in the memory card 1420 via the memory card reader 1422, and temporarily stores the program and data in the IC memory. The control unit 1424 performs a calculation process by executing the program read from the memory card 1420, and controls each section of the portable game device 1400 (executes the game) based on operation inputs performed using the arrow key 1404, the button switches 1406, and the touch panels 1416 and 1418.

Note that the main program and data may be stored in advance in the IC memory included in the control unit 1424 instead of reading a necessary program and setting data from the memory card 1420. It is also possible to employ a configuration in which the portable game device 1400 connects to the cable/wireless communication channel N (e.g., Internet, local area network (LAN), or wide area network (WAN)) via the wireless communication module 1426, and downloads a necessary program and setting data from an external device.

Outline of Game

An outline of the game according to one embodiment of the invention is described below. The game (RPG) according to one embodiment of the invention is designed so that a message posted by the player is posted to the posting site when a given game situation has been detected, and another person can temporarily participate in the game played by the player.

Note that the term “another person” used herein includes a registered player (i.e., a person who has been registered as a player of the game) and an unregistered player (i.e., a person who has not been registered as a player of the game). The term “given game situation” refers to occurrence of a given event. Note that an arbitrary state (e.g., the state (e.g., hit point, level, or accessory (item)) of a player character) during the game may be appropriately set as the given game situation.

When the given game situation is occurrence of a battle event with an enemy character, another person can participate in the game played by the player as described below utilizing the posting site. Note that the other person has registered himself as a user of the posting site, and acquired an account. A case where the other person is an unregistered player is mainly described below.

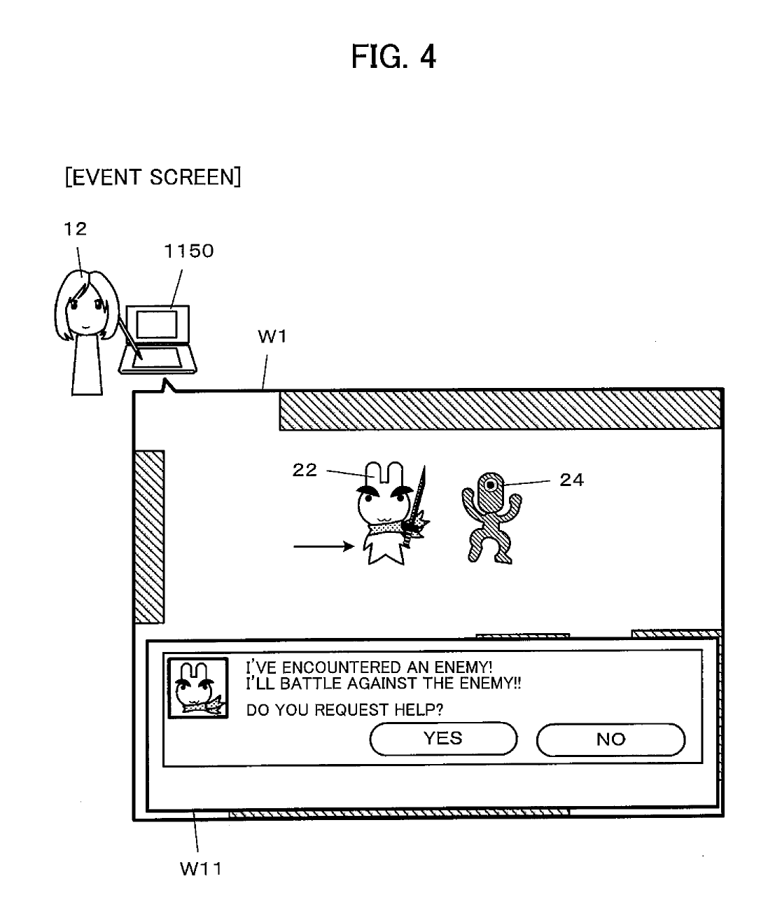

FIG. 4 shows an example of a game screen according to one embodiment of the invention. As shown in FIG. 4 (game screen W1), a player 12 moves a player character 22 within a game field. The current game situation is displayed in text in a situation description window W11 that is displayed in a lower area of the screen. The player character 22 that moves within the game field encounters an enemy character 24 at an appropriate position or timing (i.e., a battle event occurs). It is detected that the given game situation has occurred when the player character 22 has encountered the enemy character 24 (i.e., a battle event has occurred), and another person can temporarily participate in the game (i.e., participate in the event).

A message that inquires of the player 12 whether or not to request participation of another person is displayed in the situation description window W11. Note that the player 12 may determine whether or not to request participation of another person in advance corresponding to each event (e.g., battle event or treasure box event), and participation of another person may be requested upon occurrence of an event for which the player 12 has determined to request participation of another person. Alternatively, whether or not to request participation of another person may be determined based on the details of the event (e.g., the type of enemy character that has encountered the player character 22 (battle event)), or the state (e.g., a parameter such as the level or the hit point) of the player character.

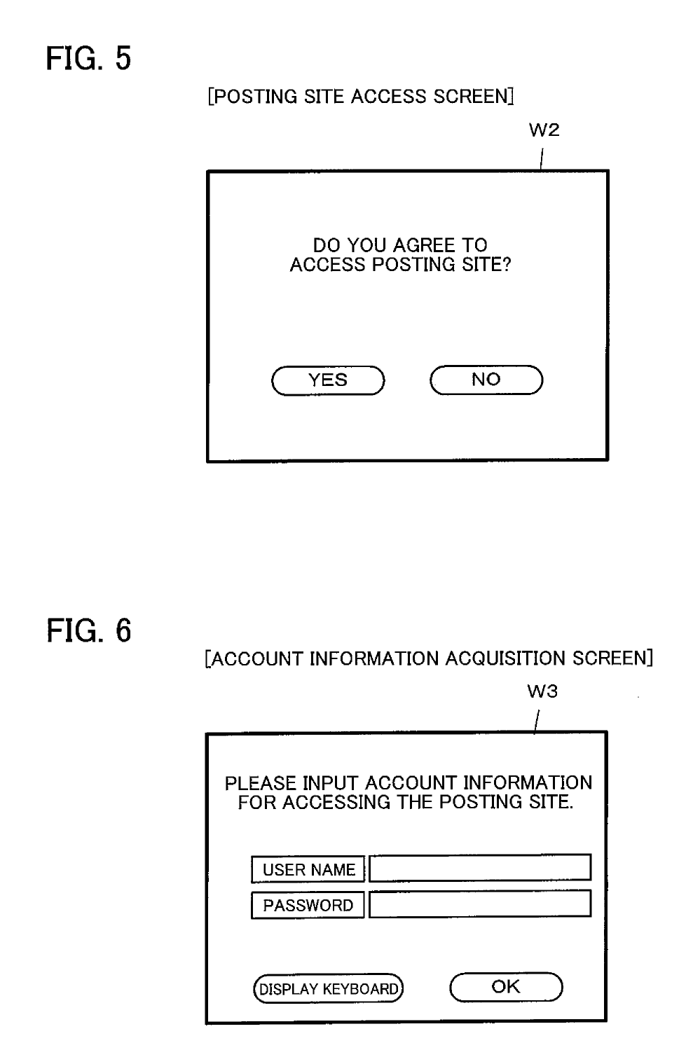

When the player 12 has selected “YES” (i.e., the player 12 requests participation of another person), a screen (see game screen W2 in FIG. 5) that inquires of the player 12 whether or not to agree to access the posting site is displayed.

When the player 12 has selected “YES” (i.e., the player 12 agrees to access the posting site), a screen (see game screen W3 in FIG. 5) that requests the player 12 to input the account information (user name and password) for accessing (using) the posting site is displayed. When the player 12 has input the account information (e.g., user name and password), the player 12 can access (use) the posting site.

Note that the account information for accessing the posting site may be registered in advance (e.g., during player registration) instead of inputting the account information upon occurrence of each event, and whether or not to agree to access the posting site may be inquired when the account information has been registered. Alternatively, whether or not to agree to access the posting site may be registered in advance, and the posting site may be accessed when it has been registered that the player 12 agrees to access the posting site.

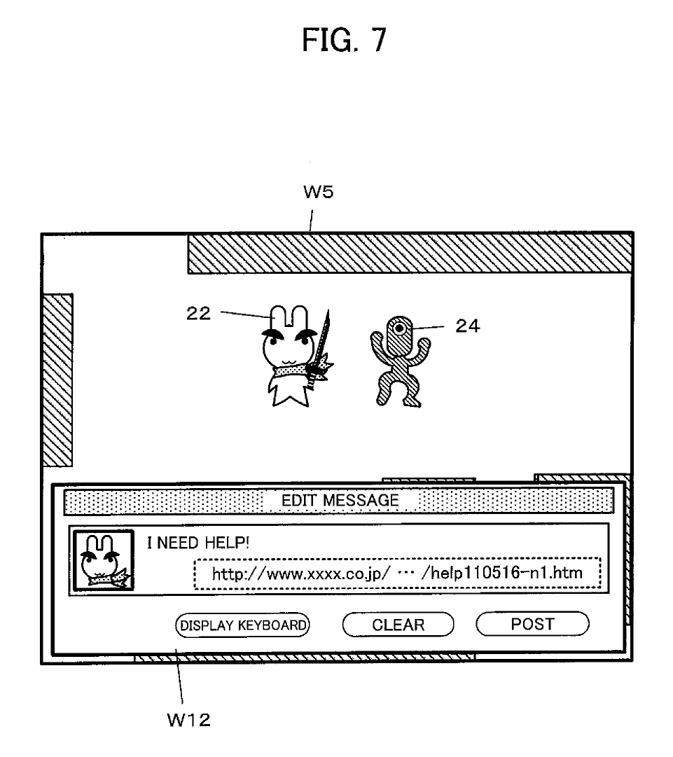

An edit window W12 (see game screen W5 in FIG. 7) that allows the player 12 to edit and check the message that is automatically posted to the posting site is then displayed. A message that explains the situation of the player character 22, and requests another person to participate in the game, and a participation URL address for another person to participate in the game, are displayed in text in the edit window W12. The participation URL address (i.e., participation code) is inherent to each given game situation. The player 12 can edit the message displayed in the edit window W12 by performing a given text input operation. Note that the player 12 can edit the message displayed in the edit window W12, but cannot edit the participation URL address. It is also possible to employ a configuration in which the player 12 cannot edit the message displayed in the edit window W12.

When the player 12 has performed (input) a given posting operation, the message is automatically posted to the posting site. Specifically, the game server system 1130 accesses the posting site using the account information about the player 12, and automatically posts the message displayed in the edit window W12 to the posting site. The function of accessing the posting site and automatically posting the message to the posting site may be implemented by utilizing a given application program interface (API) provided by the posting site.

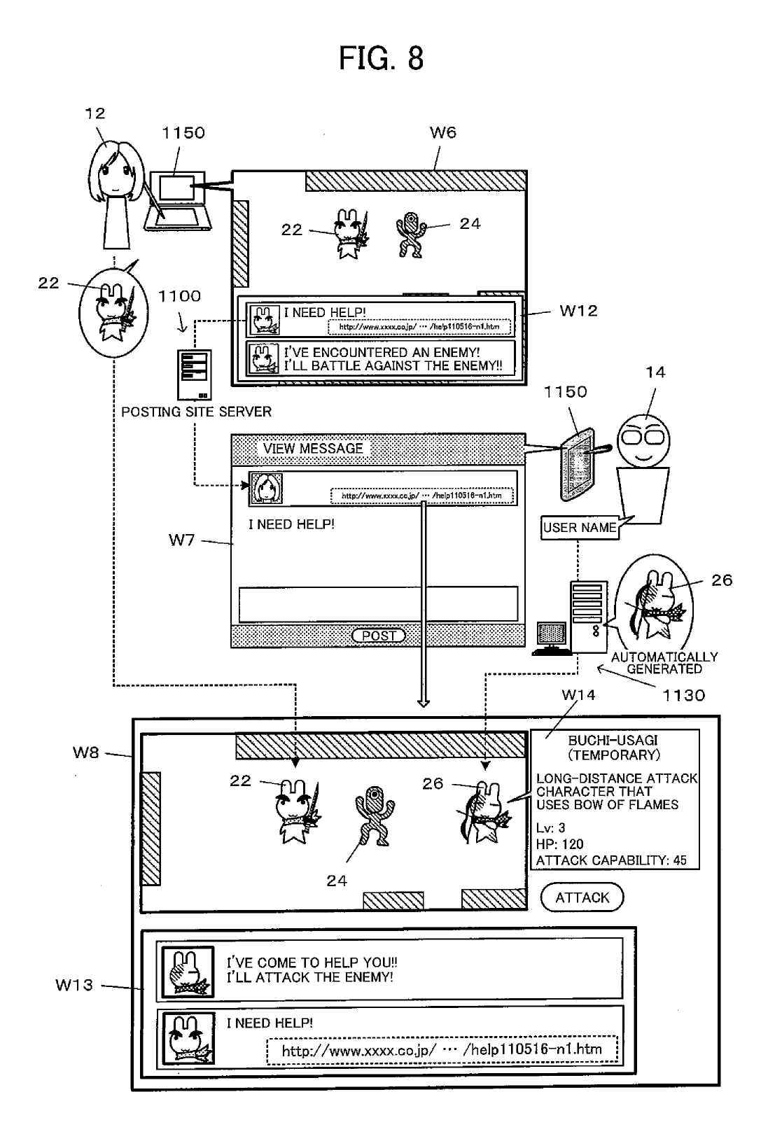

The posting site server system 1100 stores the automatically-posted message of the player 12 as posting data 1113 that corresponds to the account of the player 12 (see FIG. 8). Another person 14 who has accessed the posting site using the terminal 1150 can view the automatically-posted message of the player 12 on a posting browse screen W7, even if the other person 14 is an unregistered player.

When the other person 14 has selected the participation URL address included in the automatically-posted message, the terminal 1150 of the other person 14 accesses the game server system 1130, and the other person 14 automatically participates in the game played by the player 12 that is specified by the participation URL address. In this case, the game server system 1130 communicates with the terminal 1150 of the other person 14, prompts the other person 14 to input the user name registered on the posting site, and acquires the user name input by the other person 14.

A participation game screen W8 is then displayed on the terminal 1150 of the other person 14. The game played by the player 12 in which the other person 14 participates is displayed within the participation game screen W8 that is displayed on the terminal 1150 of the other person 14. In this example, the other person 14 participates in a battle event with an enemy character. A state in which a character 26 (participating character) operated by the other person 14 battles against an enemy character 24 together with the player character 22 is displayed within the participation game screen W8.

The participating character 26 is a character that has been automatically generated based on the user name of the other person 14 used when accessing the posting site, for example. Information (e.g., name, level, hit point (HP), special skill, and accessory) about the participating character 26 necessary for the game is displayed within a status window W14 provided in a right area of the screen. The other person 14 can cause the participating character 26 to perform a given participation operation by performing a given participation instruction operation using the participation game screen W8. When the other person 14 participates in a battle event with an enemy character, the other person 14 causes the participating character 26 to attack the enemy character 24.

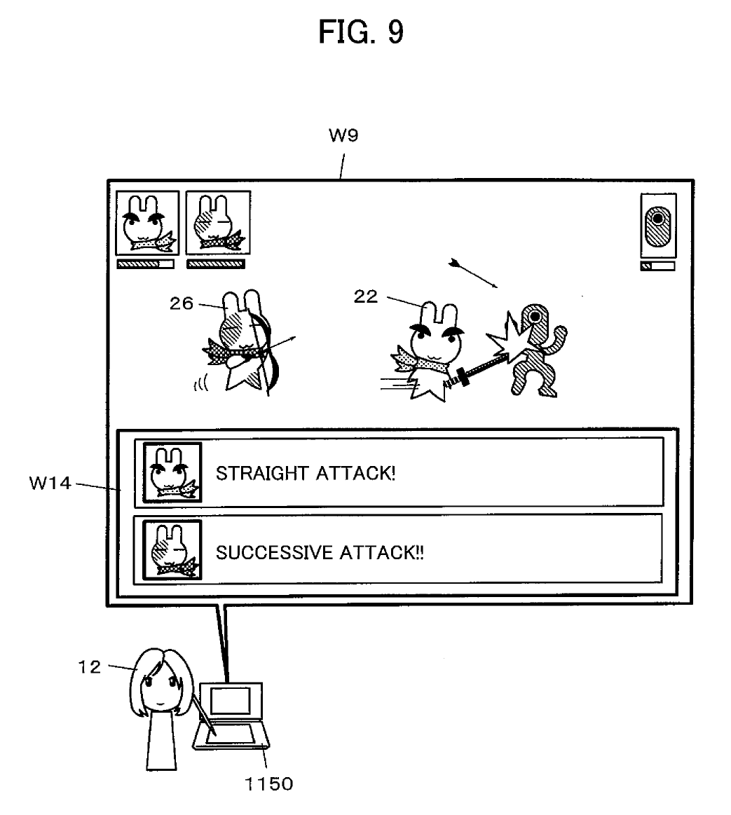

As shown in FIG. 9, a state in which the other person 14 participates in the game is also displayed within the game screen W9 of the player. In FIG. 9, a state in which the player character 22 battles against the enemy character 24 together with the participating character 26 operated by the other person 14 is displayed.

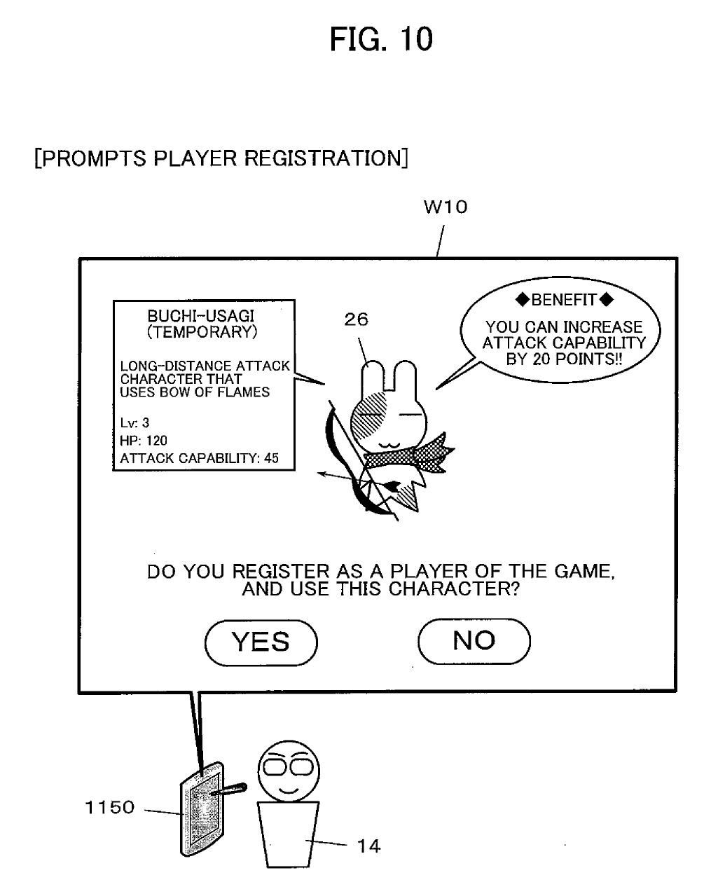

When the participation event has ended, a registration prompt screen W10 that prompts the other person 14 (unregistered player) to register himself as a player is displayed (see FIG. 10). When the other person 14 has registered himself as a player using the registration prompt screen W10, the participating character 26 used when the other person 14 participated in the game is set as the player character of the other person 14, and a message that notifies the other person 14 that the other person 14 can obtain benefit (i.e., a benefit in the game) is displayed. When the other person 14 has selected “YES” (i.e., the other person 14 desires to register himself as a player), a player registration screen is displayed. When the other person 14 has registered himself as a player, the other person 14 can play the game using the participating character 26 as the player character. Note that a character other than the participating character 26 may be set as the player character, or a character generated by changing some parts of the participating character 26 may be set as the player character.

Functional Configuration

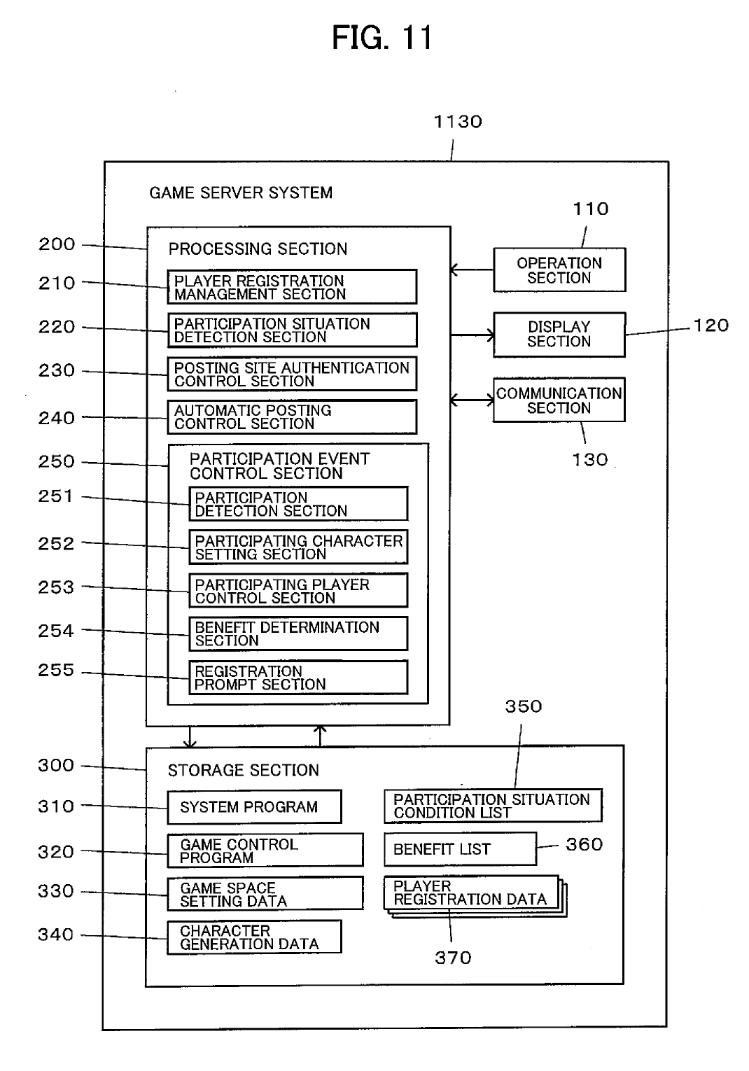

FIG. 11 is a functional configuration diagram of the game server system 1130. As shown in FIG. 11, the game server system 1130 includes an operation section 110, a processing section 200, a display section 120, a communication section 130, and a storage section 300.

The operation section 110 receives an operation input performed by the administrator of the game server system 1130, and outputs an operation signal corresponding to the operation to the processing section 200. The function of the operation section 110 may be implemented by a keyboard, a touch pad, a trackball, or the like.

The processing section 200 is implemented by a microprocessor (e.g., CPU and GPU), an application-given integrated circuit (ASIC), an IC memory, and the like. The processing section 200 exchanges data with (controls data exchange between) each functional section of the game server system 1130 including the operation section 110 and the storage section 300. The processing section 200 performs various calculation processes based on a given program, data, the operation signal from the operation section 110, a signal received from an external device (mainly the terminal 1150) via the communication section 130, and the like, and integrally controls the operation of the game server system 1130.

The processing section 200 also performs various processes for implementing the game executed by the terminal 1150. More Specifically, the processing section 200 appropriately performs various processes necessary for the game process, such as (1) a game space setting process that disposes various background objects in a virtual three-dimensional space to set a game field, and disposes objects such as the player character 22 and the enemy character 24 in the game field, (2) a process that controls the player character 22 corresponding to an instruction operation from the terminal 1150, (3) an event generation process, (4) an object hit determination process, (5) a virtual camera control process, (6) a flag management process, and (7) a process that determines whether or not a game finish condition has been satisfied.

The processing section 200 includes a player registration management section 210, a participation situation detection section 220, a posting site authentication control section 230, an automatic posting control section 240, and a participation event control section 250.

The player registration management section 210 performs a player registration process. More Specifically, the player registration management section 210 performs a process that receives the player name, the password, player character setting information, and the like from the terminal 1150, and registers a new player, a process that manages the player registration information, a process that authenticates a player corresponding to a login request from the terminal 1150, and the like. These player registration functions may be implemented in the same manner as player registration in a known online game or the like. Information about the registered player is managed and stored as player registration data 370.

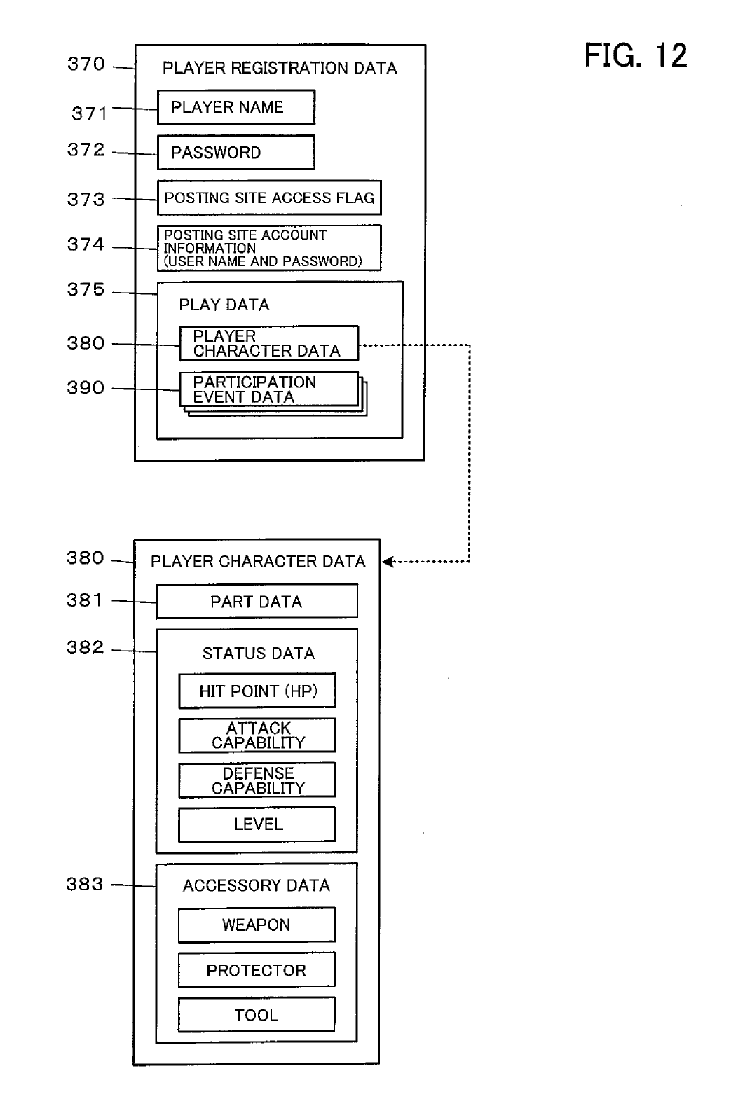

FIG. 12 is a view showing an example of the data configuration of the player registration data 370. As shown in FIG. 12, the player registration data 370 is generated corresponding to each registered player, and includes a player name 371, a password 372, a posting site access flag 373, posting site account information 374, and play data 375.

The posting site access flag 373 indicates whether or not the player has agreed to access the posting site in the game. The posting site access flag 373 is set to “0” (NO) (initial value) during player registration, and is set to “1” (YES) when the player has agreed to access the posting site. The account information (e.g., user name and password) necessary for accessing the posting site is stored as the posting site account information 374 when the posting site access flag 373 is set to “1”. The play data 375 is data for managing the game process of the player. The play data 375 includes player character data 380 and participation event data 390.

The player character data 380 is data about the player character, and includes part data 381, status data 382, and accessory data 383.

The part data 381 is data that specifies each part of the player character. A character (including the player character and the participating character) that appears in the game according to one embodiment of the invention is formed by combining various parts (e.g., trunk, face, hair, eyes, and nose). A plurality of candidate parts are provided corresponding to each part. The player creates the desired player character by selecting arbitrary candidate parts during player registration, or the game server system 1130 creates the player character by randomly selecting arbitrary candidate parts. Data about the candidate parts corresponding to each part, and candidate accessories corresponding to each accessory is included in character generation data participating operation.

The accessory data 383 is data about a weapon, a protector, a tool, and the like possessed by the player character. The status data 382 is data about the level, the attack capability, the defense capability, the hit point (HP), and the like of the player character.

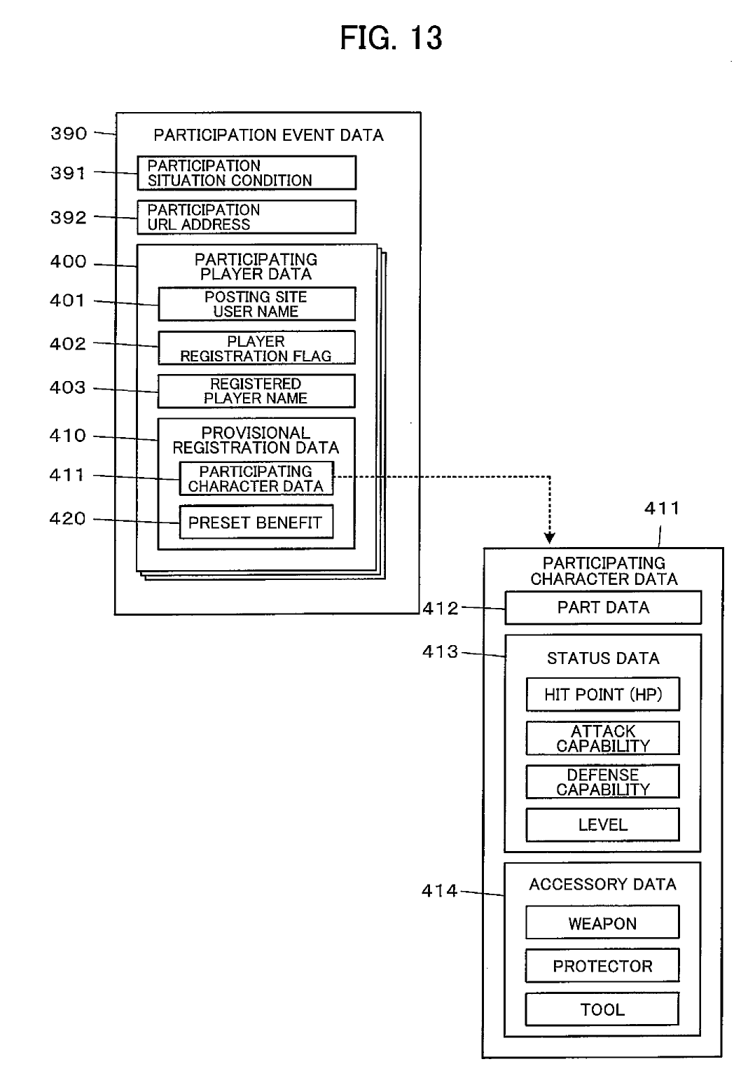

The participation event data 390 is data about the participation event that has occurred during the game. FIG. 13 shows an example of the data configuration of the participation event data 390. As shown in FIG. 13, the participation event data 390 is generated corresponding to each participation event that has occurred, and includes participation situation condition 391, a participation URL address 392, and participating player data 400.

The participating player data 400 is generated corresponding to each participating player, and includes a posting site user name 401, a player registration flag 402, a registered player name 403, and provisional registration data 410. The posting site user name 401 is a user name used when the participating player accesses the posting site. The player registration flag 402 is a flag that indicates whether or not the player has been registered in the game server system 1130. The registered player name 403 is the registered player name of the player when the player is a registered player.

The provisional registration data 410 includes participating character data 411 and a preset benefit 420. The participating character data 411 is data about a participating character created for the participating player. The participating character data 411 has the same data configuration as that of the player character data 380. The preset benefit 420 indicates benefit given to the player after the participation event has ended.

The participation situation detection section 220 shown in FIG. 11 detects whether or not the situation of the game played by the player of the terminal 1150 has satisfied a participation situation condition. The participation situation condition is specified in a participation situation condition list 350. When the participation situation detection section 220 has detected that the participation situation condition has been satisfied, the participation situation detection section 220 generates the participation URL address for another person to participate in the game as the participation code.

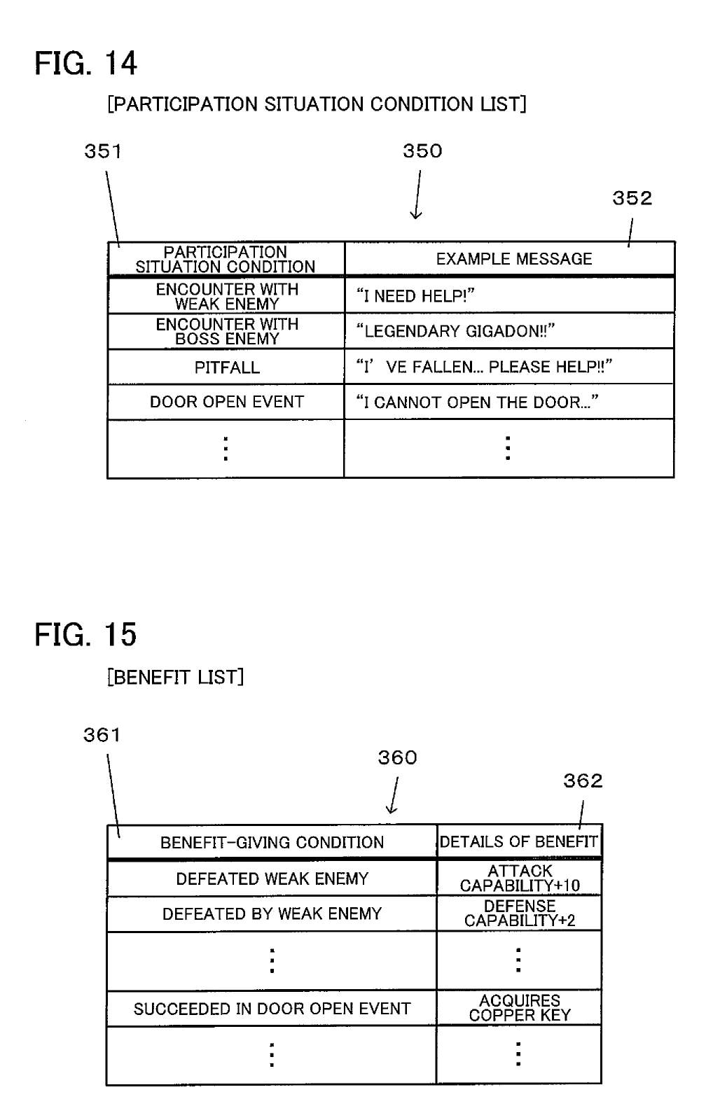

FIG. 14 is a view showing an example of the data configuration of the participation situation condition list 350. As shown in FIG. 14, the participation situation condition list 350 stores a participation situation condition 351 and an example message 352.

The posting site authentication control section 230 accesses the posting site based on the posting site account information acquired from the player to obtain authentication, and generates signature data that facilitates subsequent authentication. The above control process may be implemented by appropriately utilizing the API or the like provided by the posting site.

The automatic posting control section 240 automatically posts a message to the posting site. More Specifically, when the participation situation detection section 220 has detected that the participation situation condition has been satisfied, the automatic posting control section 240 displays the edit window W12 that displays an example message that corresponds to the participation situation condition, and the participation URL address (see FIG. 7). In this example, only the example message can be edited (i.e., the participation URL address cannot be edited). The example message corresponds to the participation situation condition that is specified in the participation situation condition list 350, and has been determined to be satisfied. When a posting operation has been performed, the automatic posting control section 240 accesses the posting site, and automatically posts the message that is currently displayed in the edit window W12. The automatic posting process may be implemented by appropriately utilizing the API or the like provided by the posting site.

The participation event control section 250 includes a participation detection section 251, a participating character setting section 252, a participating player control section 253, a benefit determination section 254, and a registration prompt section 255. When the participation situation detection section 220 has determined that the participation situation condition has been satisfied, the participation event control section 250 controls the process of the event (participation event) that has YESd another person to participate in the game.

The participation detection section 251 detects participation of another person based on a request for connection to the participation URL address. More Specifically, the participation detection section 251 specifies the terminal 1150 that has issued a request for connection to the participation URL address, and acquires the user name of the other person (participating player) used on the posting site from the terminal 1150. The participation detection section 251 refers to the player registration data 370, and determines whether or not the participating player has been registered in the game server system 1130 using the acquired user name (i.e., specifies the participating player).

The participating character setting section 252 sets a participating character that is operated by the participating player. More Specifically, when the participating player is a registered player, the participating character setting section 252 refers to the player registration data 370, and sets the player character of the participating player to be the participating character. When the participating player is an unregistered player, the participating character setting section 252 generates a new participating character.

The participating character is generated by utilizing the user name of the participating player, for example. Specifically, parts (e.g., face, body, and hair), accessories (e.g., weapon, protector, and tool), and status (e.g., level, attack capability, and defense capability) of the character are selected (determined) by comparing the number of characters of the user name, the type of each character, the number of respective characters, and the like with a given rule. Alternatively, a plurality of characters formed by combining arbitrary parts, accessories, and status may be provided in advance, and an identification number may be assigned to each character. A character having an identification number that corresponds to a value obtained based on the number of characters of the user name and the like using a given function may be determined to be the participating character.

Note that the participating character may be generated by a method other than a method using the user name. For example, when the participating player has agreed to access the posting site, posting information (e.g., information about the message, the posting date, the posting target (destination) user, the position during posting, and the like) about the participating player may be acquired from the posting site server system 1100, and the participating character may be generated using the posting information about the participating player (e.g., the posting count, the posting frequency, or the presence or absence of a given keyword included in the message).

The participating player control section 253 performs a process relating to the participating player. More Specifically, the participating player control section 253 causes the terminal 1150 of the participating player to display a participating game screen (see FIG. 8) that displays a game image that shows the current state of the game, and the description of the participating character 26 (status window W14).

The benefit determination section 254 determines the benefit that is given to the participating player in reward for participation according to a benefit list 360. FIG. 15 is a view showing an example of the data configuration of the benefit list 360. As shown in FIG. 15, the benefit list 360 stores a benefit-giving condition 361 and details of benefit 362. The benefit-giving condition 361 specifies the type and the result of the participation situation condition.

In one embodiment of the invention, an identical benefit is given to each participating player corresponding to one participation event. Note that a different benefit may be given to each participating player corresponding to one participation event. For example, a different benefit may be given to the participating player depending on the extent that the participating player participates in the participation event (e.g., the degree of damage applied to the enemy character), or depending on whether or not the participating player is a registered player.

The registration prompt section 255 performs a process (prompt process) that prompts the participating player to register himself in the game server system 1130 as a player after the participation event has ended when the participating player is an unregistered player. The registration prompt section 255 causes the terminal 1150 of the participating player to display a registration prompt screen (see FIG. 10) that displays the participating character 26 used during the current participation event, and the benefit determined by the benefit determination section 254.

The display section 120 displays a display screen based on an image signal input from the processing section 200.

The function of the display section 120 may be implemented by an image display device such as a flat panel display, a cathode-ray tube (CRT), or a projector.

The communication section 130 connects to the communication channel N to implement communication with an external device (mainly the posting site server system 1100 and the terminal 1150). The function of the communication section 130 may be implemented by a transceiver, a modem, a terminal adapter (TA), a jack for a communication cable, a control circuit, or the like.

The storage section 300 stores a system program and data for implementing various functions for causing the processing section 200 to integrally control the game server system 1130, and is used as a work area for the processing section 200. The storage section 300 temporarily stores the results of calculations performed by the processing section 200 according to various programs, data input from the operation section 110, data received from the communication section 130, and the like. The function of the storage section 300 may be implemented by an IC memory (e.g., RAM or ROM), a magnetic disk (e.g., hard disk), an optical disk (e.g., CD-ROM or DVD), or the like. In one embodiment of the invention, the storage section 300 stores a system program 310, a game control program 320, game space setting data 330, the character generation data participating operation, the participation situation condition list 350, the benefit list 360, and the player registration data 370.

The system program 310 implements the basic functions of the game server system 1130 as a computer. The game control program 320 implements the game control process according to one embodiment of the invention. The processing section 200 reads and executes the game control program 320. The game space setting data 330 defines the game space. The game space setting data 330 includes data about a background object (e.g., ground) disposed in the virtual third-dimensional space, position information about the background object, a texture applied to the background object, and the like.

Flow of Process

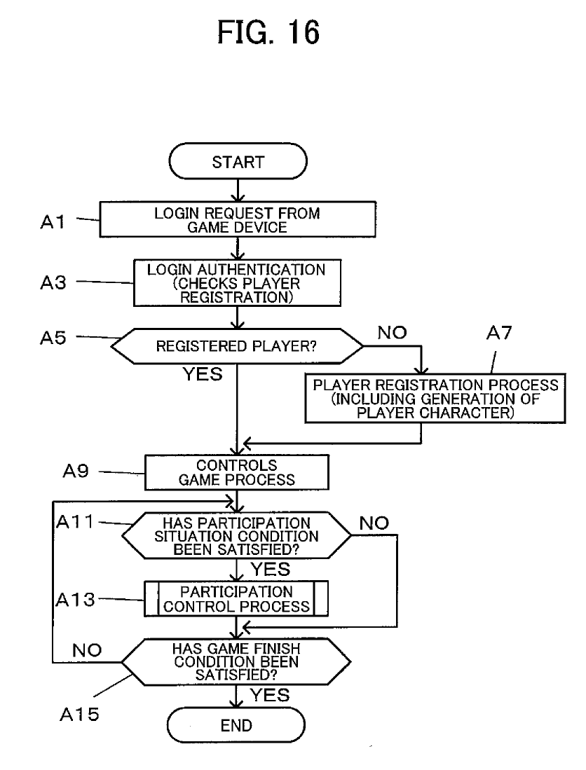

FIG. 16 is a flowchart illustrating the flow of a game control process. The game control process is implemented by causing the processing section 200 of the game server system 1130 to execute the game control program 320.

As shown in FIG. 16, when a login request has been received from the terminal 1150 (step A1), the player registration management section 210 checks the player name and the password that have been received together with the login request, and determines whether or not the user of the terminal 1150 has been registered as a player (login authentication) (step A3). When the user of the terminal 1150 has not been registered as a player (step A5: NO), the processing section 200 performs a player registration process (e.g., sets the player name and the password, and generates (sets) the player character) (step A7).

The processing section 200 then controls the game process using the player registration data 370 (step A9). The participation situation detection section 220 determines whether or not the current game situation has satisfied the participation situation condition during the game. When it has been detected that the participation situation condition has been satisfied (step A11: YES), the processing section 200 performs a participation control process (step A13).

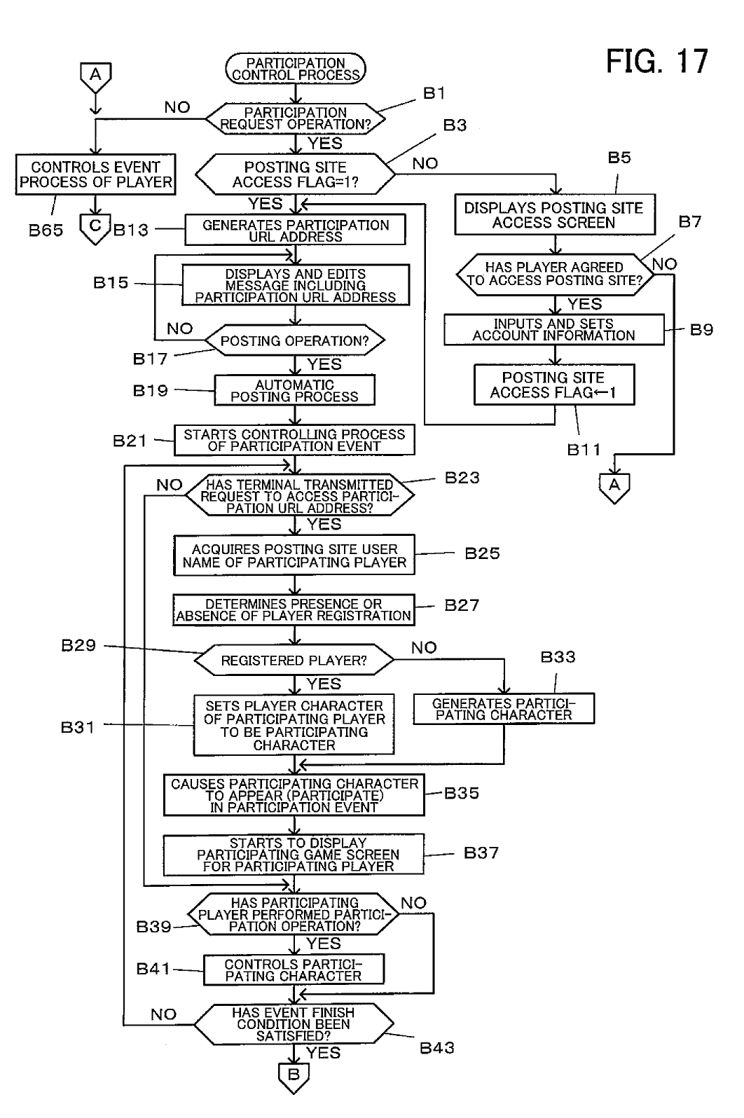

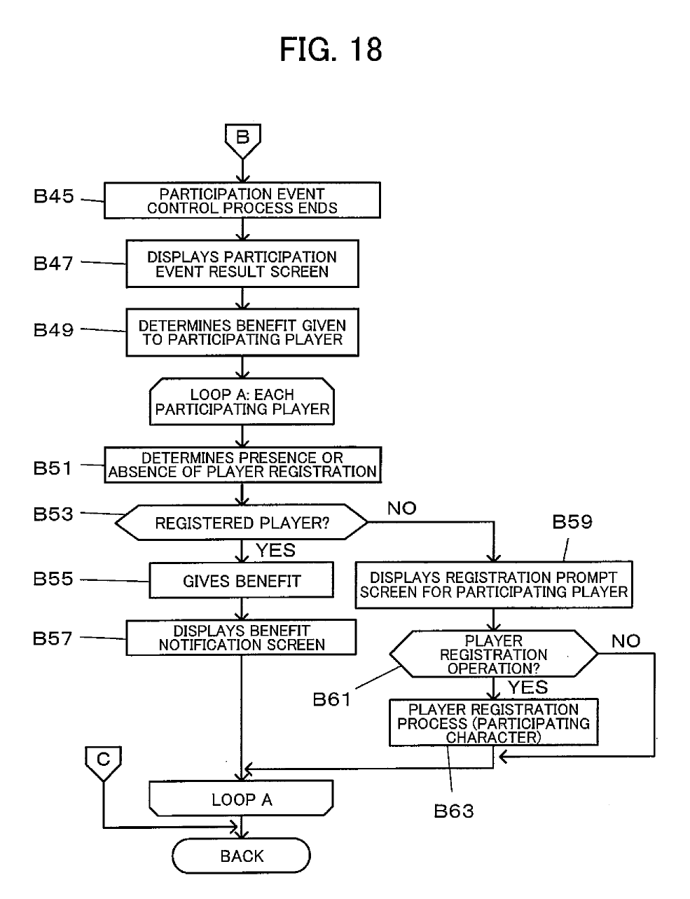

FIGS. 17 and 18 are flowcharts illustrating the flow of the participation control process. As shown in FIG. 17, the participation event control section 250 causes the terminal 1150 of the player to display a screen that allows the player to select whether or not to request another person to participate in the game (see FIG. 4). When the player has selected to request another person to participate in the game (step B1: YES), the participation event control section 250 refers to the posting site access flag, and determines whether or not the player has agreed to access the posting site.

When the posting site access flag is set to “0” (NO) (step B3: NO), the participation event control section 250 causes the terminal 1150 of the player to display a screen that requests the player to agree to access the posting site (see FIG. 5) (step B5). When the player 12 has agreed to access the posting site (step B7: YES), the participation event control section 250 causes the terminal 1150 of the player to display a screen that prompts the player to input the account information (user name and password) for accessing the posting site, and sets (stores) the input account information as the posting site account information 374 about the player (step B9). The participation event control section 250 also sets the posting site access flag to “1” (step B11).

The participation situation detection section 220 then generates the participation URL address for the current participation event (step B13). The automatic posting control section 240 then causes the terminal 1150 of the player to display an example message that corresponds to the participation situation condition that has been determined to be satisfied, and the participation URL address (step B15). When the player has performed a posting operation (step B17: YES), the automatic posting control section 240 accesses the posting site, and automatically posts the message (step B19). The process of the participation event is then controlled (step B21).

When the participation detection section 251 has detected that the terminal 1150 (game device) of another person has transmitted a request to access the participation URL address (step B23: YES), the participation detection section 251 specifies the terminal 1150 that has transmitted the request. The participation detection section 251 communicates with the specified terminal 1150, prompts the other person to input the user name for accessing the posting site, and acquires the input user name (step B25). The participation detection section 251 then checks the acquired user name, and determines whether the participating player is a registered player or an unregistered player (step B27). When the participating player is a registered player (step B29: YES), the participating character setting section 252 sets the player character of the participating player to be the participating character (step B31). When the participating player is an unregistered player (step B29: NO), the participating character setting section 252 generates (sets) the participating character using the acquired user name (step B33).

Note that it is also possible to prompt the participating player to input the player name registered in the game when prompting the participating player to input the user name for accessing the posting site (step B25). In this case, it is determined that the participating player is a registered player when the participating player has input the player name.

The participating character is then caused to appear (participate) in the participation event (step B35). The terminal 1150 of the participating player starts to display the participating game screen for the participating player (step B37). When the participating player has performed a participation operation (step B39: YES), the participating character 26 is controlled corresponding to the operation (step B41).

Whether or not a participation event finish condition has been satisfied is then determined When the participation event finish condition has not been satisfied (step B43: NO), the step B23 is performed again. When the participation event finish condition has been satisfied (step B43: YES), the participation event control process ends (step B45). The terminals 1150 of the player and the participating player then display a participation event result screen (step B47).

The benefit determination section 254 then determines a benefit given to the participating player corresponding to the participation situation condition and the results of the participation event (step B49).

A loop A process is then performed on each participating player. In the loop

A process, whether or not the participating player is a registered player or an unregistered player is determined (step B51). When the participating player is a registered player (step B53: YES), the benefit that has been determined is given to the participating player (step B55), and a screen that notifies the participating player that the benefit has been given to the participating player is displayed on the terminal 1150 of the participating player (step B57).

When the participating player is an unregistered player (step B53: NO), the registration prompt screen (see FIG. 10) that prompts the participating character to register himself as a player, and shows the participating character used during the current participation event together with the benefit given to the participating character when the participating character registers himself as a player, is displayed on the terminal 1150 of the participating player (step B59).

When the participating player has performed a registration operation (step B61: YES), the player registration management section 210 performs the player registration process (step B63). In this case, the participating character is set as the player character. The loop A is thus completed. When the loop A process has been performed on all of the participating players, the participation control process ends.

Again referring to FIG. 16, when the participation control process has ended, the processing section 200 determines whether or not a game finish condition has been satisfied. When the game finish condition has not been satisfied (step A15: NO), the process is repeated from the step A11. When the game finish condition has been satisfied (step A15: YES), the processing section 200 stops controlling the game process.

The processing section 200 then stops the game control process.

Effects

According to the above embodiments, a message that includes the participation URL address for another person to participate in the game is automatically posted to the posting site when the game situation has satisfied a given participation situation condition. The other person can participate in the game by accessing the participation URL address. This makes it possible to implement a novel game that enables another person to participate in the game played by the player by utilizing the posting site. The player can have a novel game experience in which the player is linked to another person through the posting site.

The participating character 26 operated by the other person is generated, and participates (appears) in the game, and the terminal 1150 of the other person displays a game screen that shows the state of the game. Therefore, even if the other person is an unregistered player (i.e., has not been registered as a player of the game), the other person can experience the game by watching the game screen in which he participates in the game played by the player, and may become interested in the game.

When the other person is an unregistered player, the registration prompt screen W9 that prompts the other person to register himself as a player of the game, and play the game using the participating character 26 as the player character is displayed on the terminal 1150 of the other person when the participation event has ended. This makes it possible to prompt the other person to register himself as a player of the game, and use the character that appeared in the game as his character. This is effective as the prompt means. It is expected that a further effect can be obtained by giving a benefit to the other person.

Modifications

Embodiments to which the invention may be applied are not limited to the above embodiments. Various modifications and variations may be made of the above embodiments without departing from the scope of the invention.

(A) Automatic Posting After Participation Event Has Ended

A message that is posted by the participating player and relates to the current participation event may be automatically posted after the participation event has ended. Specifically, the game server system 1130 may automatically post a message that is posted by the participating player and includes a brief description of the current participation event (e.g., the names and the number of enemy characters, techniques used, and the battle time), the results of the current participation event, and information (e.g., the user name on the posting site) about the participating player (i.e., the other person). The message may also include the URL address for the unregistered player to register himself as a player.

(B) Automatic Posting to Posting Site

Although the above embodiments have been described taking an example in which the game server system 1130 accesses the posting site, and automatically posts a message. Note that the terminal 1150 may access the posting site, and automatically post a message. Specifically, the terminal 1150 may have the functions of the posting site authentication control section 230 and the automatic posting control section 240 included in the game server system 1130. The game server system 1130 may instruct the terminal 1150 to automatically post a message to the posting site when a posting instruction has been detected (see FIG. 7), and the terminal 1150 may access the posting site, and automatically post a message according to the instruction from the game server system 1130. In this case, the terminal 1150 implements the steps B9 and B19 of the participation control process (see FIGS. 17 and 18).

(C) Terminal 1150

The terminal 1150 is not limited to the consumer game device 1200, the smartphone 1300, and the portable game device 1400. For example, an electronic instrument (computer) that may be used as a game device (e.g., arcade game device), or an electronic instrument (e.g., information terminal, compact digital camera, music player, personal computer, or car navigation system) that can execute application software is considered to include a computer that can execute a program, or considered to be a computer. Therefore, such an electronic instrument may be used as the terminal 1150.

(D) Applicable Game

The above embodiments have been described taking an RGP as an example of the game. Note that the game is not limited thereto. The game may be a a shooting game, a fighting game, an action game, a dating simulation game, a breeding game, a strategy game, or the like.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

What is claimed is:

1. A method that causes a server system to control a process of a game played by a registered player, the method comprising:
posting a message that is posted by the registered player and includes a participation code to a posting site when a game situation of the registered player has satisfied a given participation situation condition that allows an unregistered player to participate in the game; and
changing the process of the game played when the server system has been accessed by the unregistered player using the participation code.

2. The method as defined in claim 1, further comprising:
transmitting a signal that notifies the unregistered player that the unregistered player has participated in the game played by the registered player when the server system has been accessed by the unregistered player.

3. The method as defined in claim 2, further comprising:
generating a character of the unregistered player when the server system has been accessed by the unregistered player; and
transmitting a display control signal for a game screen in which a character of the registered player and the character of the unregistered player appear when the server system has been accessed by the unregistered player.

4. The method as defined in claim 3, further comprising:
transmitting a display control signal for a prompt screen that prompts the unregistered player to register himself as a player after transmitting the display control signal for the game screen; and
setting the character of the unregistered player as a character that is used in the game, and giving a given benefit to the unregistered player when a signal that indicates that the unregistered player has registered himself as a player has been received.

5. The method as defined in claim 1,
the posting of the message including posting the message when the participation situation condition has been satisfied, and a signal that requests the unregistered player to participate in the game has been received from the registered player.

6. The method as defined in claim 1, further comprising:
posting a message that is posted by the registered player and indicates that the unregistered player has participated in the game played by the registered player to the posting site when the server system has been accessed by the unregistered player.

7. A method that causes a server system to control a process of a game played by a registered player, the method comprising:
transmitting a signal that instructs the registered player to post a message that includes a participation code to a posting site when a game situation of the registered player has satisfied a given participation situation condition that allows an unregistered player to participate in the game; and
changing the process of the game played when the server system has been accessed by the unregistered player using the participation code.

8. A server system comprising:
a posting section that posts a message that is posted by a registered player and includes a participation code to a posting site when a game situation of the registered player has satisfied a given participation situation condition that allows an unregistered player to participate in the game; and
a game process change section that changes a process of a game played by the registered player when the server system has been accessed by the unregistered player using the participation code.

9. A server system comprising:
a posting instruction section that transmits a signal that instructs a registered player to post a message that includes a participation code to a posting site when a game situation of the registered player has satisfied a given participation situation condition that allows an unregistered player to participate in the game; and
a game process change section that changes a process of a game played by the registered player when the server system has been accessed by the unregistered player using the participation code.
